(19) United States
(12) Patent Application Publication
(10) Pub. No.: US 2023/0106418 A1
(43) Pub. Date: Apr. 6, 2023

(54) SYSTEMS AND METHODS FOR FACILITATING FINANCIAL TRANSACTIONS

(71) Applicant: Wells Fargo Bank, N.A., San Francisco, CA (US)

(72) Inventors: Azita Asefi, Vacaville, CA (US); Marcia Klingensmith, Pleasant Hill, CA (US); Joon Maeng, Newcastle, WA (US); Jenny Y. Tao, Belmont, CA (US); Michael R. Thomas, San Francisco, CA (US)

(21) Appl. No.: 15/655,982

(22) Filed: Jul. 21, 2017

(51) Int. Cl. G06Q 20/40; G06Q 20/32

(52) U.S. Cl. CPC G06Q 20/405; G06Q 20/3278; G06Q 20/3276; G06Q 20/40145

(57) ABSTRACT

Systems and methods for facilitating financial transactions are provided. A mobile computing device can receive a payment request from a merchant computing device. The payment request can include an amount of the financial transaction. The mobile computing device can transmit, via a computer network, the payment request and authentication information to a financial institution computing device. The mobile computing device can receive, via the computer network, authorization information from the financial institution computing device. The authorization information can include information indicating approval of the payment request. The mobile computing device can transmit the authorization information to the merchant computing device.

### BACKGROUND

The present disclosure relates generally to the field of systems that use mobile devices to conduct transactions. More specifically, the present disclosure relates to systems and methods for enabling individuals and merchants to use mobile devices to conduct financial transactions without the use of a traditional proprietary transaction network.

A transaction for products or services can be completed using funds included in an account held by the buyer. Often, such transactions are conducted using credit cards, debit cards, checks, or cash. However, most people carry some type of mobile handheld electronic device, such as a cellular phone, smart phone, mobile handheld wireless e-mail device, personal digital assistant, portable gaming devices, and so on, which may store information related to financial accounts held by the user. Furthermore, many of these devices have a wireless Internet connection. A person may wish to make payments to merchants or other individuals using these mobile devices. However, information relating to payments must typically be transmitted over a proprietary network, such as a network owned or operated by a credit card company, in order to process such payments, and the owner of the proprietary network typically collects additional fees not included in the original price of the transaction. Enhanced systems and methods of facilitating such transactions would be desirable.

### SUMMARY

According to one example embodiment, a computer-implemented method for facilitating a financial transaction includes receiving, by a mobile computing device, a payment request from a merchant computing device. The payment request includes an amount of the financial transaction. The method includes transmitting, by the mobile computing device via a computer network, the payment request and authentication information to a financial institution computing device. The method includes receiving, by the mobile computing device via the computer network, an authorization message from the financial institution computing device responsive to the financial institution computing device determining that the payment request is approved. The authorization message includes information indicating approval of the payment request. The method also includes transmitting, by the mobile computing device, the authorization message to the merchant computing device. The mobile computing device is structured to facilitate the financial transaction by routing each of the payment request and the authorization message between the merchant computing system and the financial institution computing system without use of a proprietary transaction network

According to another example embodiment, a system for facilitating a financial transaction includes a mobile computing device having a processor and instructions stored in non-transitory machine-readable media. The instructions are configured to cause the mobile computing device to receive a payment request from a merchant computing device. The payment request includes an amount of the financial transaction. The instructions are configured to cause the mobile computing device to transmit, via a computer network, the payment request and authentication information to a financial institution computing device. The instructions are configured to cause the mobile computing device to receive, via the computer network, an authorization message from the financial institution computing device responsive to the financial institution computing device determining that the payment request is approved. The authorization message includes information indicating approval of the payment request. The instructions are also configured to cause the mobile computing device to transmit the authorization message to the merchant computing device. The instructions are further configured to cause the mobile computing device to facilitate the financial transaction by routing each of the payment request and the authorization message between the merchant computing system and the financial institution computing system without use of a proprietary transaction network.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a block diagram illustrating data flow in a conventional payment processing system using a proprietary transaction network, according to an example embodiment;

FIG. 2 is a block diagram illustrating data flow in an alternative payment processing system that does not rely on a proprietary transaction network, according to an example embodiment;

FIG. 3 is a block diagram of a computer-implemented payment processing system, according to an example embodiment; and

FIG. 4 is a flow chart illustrating a method for facilitating a financial transaction that can be implemented using the payment processing system shown in FIG. 3, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein are for the purpose of description only and should not be regarded as limiting.

Referring generally to the figures, systems and methods for facilitating a financial transaction are described. More particularly, the present disclosure relates to improved systems and methods for processing payments that allow the payments to be completed without the use of a traditional transaction network. Many financial transactions are completed electronically. For example, credit cards, debit cards, stored value cards, and other devices allow a user to complete electronic payments. A user maintains financial accounts at one or more financial institutions, and each account is linked to one of the various types of cards or other devices referred to above. To complete payment to a merchant, the user provides the card associated with the account to be used for payment. The card is scanned via a point-of-sale (POS) computing device by the merchant such that the POS device can obtain information (e.g., an account number, an identity of the user, etc.) from the card. The information obtained from the card is transmitted to the issuing financial institution from the POS device via a proprietary transaction network. In some instances, the user's account information may be stored on a mobile electronic device, such as a smartphone, and the merchant's POS device may retrieve the account information from the user's mobile device rather than from a card. However, even when a mobile device is used, the information obtained from the user is typically routed to the issuing financial institution from the merchant's POS device via the proprietary transaction network.

The transaction network is generally owned and/or operated by a third party. For example, the transaction network may be owned by a credit card company such as Visa®, MasterCard®, American Express®, Discover®, etc. In many instances, the third party who owns and/or operates the transaction network will charge a fee for the use of the network. As a result, the cost for processing the transaction may be a non-trivial amount relative to the price of the goods or services that the user has purchased, and the difference must be paid by either the user or the merchant (or both). For example, the owner or operator of a transaction network may charge a fee in the range of about $0.10 to about $0.25 plus 2% to 3% of the total value of the transaction.

Additionally, use of a proprietary transaction network exposes users to risk of data theft. For example, in the traditional electronic payments systems described above, the user's payment information is first collected by the merchant, and then transmitted by the merchant over the proprietary transaction network. Thus, an unauthorized third party may gain access to the user's payment information either from the merchant or by intercepting the payment information as it traverses the proprietary transaction network. The present disclosure is generally directed to improved systems and methods that allow financial transactions to be completed without the use of a traditional transaction network, thereby reducing the price for processing such transactions and reducing the risk of unauthorized access to a user's personal information associated with such transactions.

In an example embodiment of the present disclosure, a user's mobile device may be configured to serve as a POS device capable of transmitting transaction information to the user's financial institution. Furthermore, the user's mobile device can be configured to transmit the transaction information without the use of the traditional third-party-owned transaction network. For example, in some arrangements, a user may initiate a transaction with a merchant by bringing goods to be purchased to a POS device or other computing device owned by the merchant. The merchant computing device can scan the goods and generate an electronic bill or payment request to be sent to the user's mobile computing device. The merchant computing device can send the payment request to the user's mobile computing device via near-field communication (NFC), Bluetooth, Wi-Fi, optical transmission techniques (e.g., a QR code), etc. The user's mobile computing device then transmits the payment request along with authentication information, such as biometric data and/or a device token associated with the mobile computing device, directly to the user's financial institution.

In some arrangements, the mobile device is configured to send the bill and the authentication information to the financial institution via a generic computer network, such as a cellular network or the Internet, rather than via a proprietary transaction network. The financial institution can authorize the transaction and transmit an indication that the transaction has been authorized back to the user's mobile device using the generic computer network, again bypassing the proprietary transaction network. Finally, the user's mobile device transmits the indication that the transaction has been authorized to the merchant computing device, and the transaction is completed accordingly. As a result, the proprietary transaction network is not used, and the transaction may be completed in a less expensive manner, representing a significant technical improvement in the field of facilitating electronic financial transactions.

The arrangement described above also achieves the technical effect of reducing unauthorized access to a user's payment information. For example, the traditional payment systems described above generally require the user to provide payment information to the merchant, who then transmits the payment information to a financial institution via the proprietary payment network. In some arrangements, the merchant also may save some or all of the user's payment information. Payment information may include private or otherwise sensitive information about the user, such as an account number for a financial account held by the user or personal information about the user's identity. Providing this information to the merchant can potentially expose the user to risk of data theft, for example, if the merchant's computing systems are compromised by a fraudster or other malicious third party in the future. In some arrangements, certain user information, such as an account number, may be “tokenized” or otherwise abstracted prior to being transferred to the merchant. However, the information provided to the merchant still typically includes personal identifying information of the user, which may put the user at risk if the information is stolen. Bypassing the proprietary transaction network and allowing the user to send the information directly to the financial institution, as described in this disclosure, reduces this risk.

In addition, because user communicates directly with the financial institution via the user computing device, the financial institution may be able to infer a portion of the payment information without ever receiving it from the user. For example, the financial institution may infer an account number based on an identity of the user (or the user's computing device). The user computing device may send user identity information or a unique device number associated with the user computing device to the financial institution. The financial institution can maintain records indicating the account numbers associated with its customers. Thus, by comparing the information received from the user computing device to its stored records, the financial institution can determine an account number to be used for the payment. As a result, the account number does not have to be transmitted to the financial institution, thereby reducing the risk that the account number could be intercepted in transit to the financial institution.

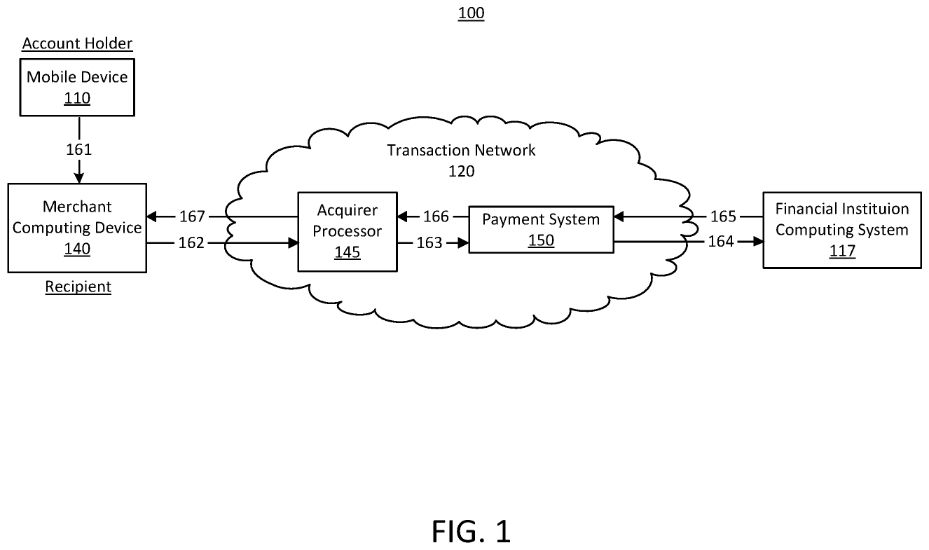

The systems and methods of this disclosure also can allow the financial institution to maintain more control over the format in which electronic payment data is transmitted and received to process a transaction. In typical payment processing systems that rely on a proprietary transaction network, the payment data can be transmitted by the merchant via a proprietary transaction network to an acquirer processor and then forwarded to the financial institution. An example of such an arrangement is described below in connection with FIG. 1. Accordingly, the financial institution must accept payment information in the format used by the acquirer processor and the payment system. However, bypassing the proprietary transaction network gives the financial institution the ability to select e format in which electronic payment data is transmitted and received. For example, in some arrangements the financial institution may create and publish an application that can be downloaded to the user computing device to allow the user computing device to send payment information directly to the financial institution. The application can be configured to provide services such as tokenization of account numbers or other personal information, as well as data encryption, prior to transmitting the information to the financial institution. Thus, when the financial institution wishes to alter, for example, an encryption technique for electronic payment information, the financial institution can provide such functionality to the application executing on the user computing device via a software update, rather than relying on the acquirer processor and payment system to update their own protocols for encrypting data.

FIG. 1 is a block diagram illustrating data flow in a conventional payment processing system 100 using a proprietary transaction network 120, according to an example embodiment. The blocks shown in FIG. 1 correspond to various computing devices, and the numbered arrows shown in FIG. 1 illustrate the flow of data between the computing devices. The system 100 includes a mobile device 110, a financial institution computing system 117, a merchant computing device 140, an acquirer processor 145, and a payment system 150. The acquirer processor 145 and the payment system 150 are positioned within the transaction network 120 and serve as intermediaries for routing information between the merchant computing device 140 and the financial institution 117. In some arrangements, the mobile device 110 is owned and/or operated by a user who wishes to purchase goods or services from the merchant. The user may be a business entity or an individual consumer that has one or more source accounts with a financial institution. The source accounts may include business or consumer demand deposit, credit card, debit card accounts, lines of credit, and so on. The merchant owns and/or operates the merchant computing device 140, and the financial institution owns and/or operates the financial institution computing system 117. The system 100 facilitates the completion of such a transaction via the transaction network 120.

The mobile device 110, the financial institution computing system 117, the acquirer processor 145, and the payment system 150 may each include a computer system (e.g., one or more servers each with one or more processing circuits), each having a processor and memory. The processors may be implemented as application specific integrated circuits (ASICs), one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and/or non-transitory computer storage media. The memory may include data base components, object code components, script components, or any other type of information structure for supporting the various activities and information structures described herein. The memory may be communicably connected to the processor and include computer code or instructions for executing one or more processes described herein. Additional details of the implementations of these components are described further below.

At 161, the mobile device 110 transmits information to the merchant computing device 140. The information may include account information (such as a number of a bank account held at the financial institution), card information (such as the number of a debit card linked to the account), and as other information that may be required for processing the transaction. For example, in some arrangements, the mobile device 110 also transmits a device token, a username, or a password that may be used to authenticate the transaction. It should be understood that, in some implementations, the mobile device 110 may be located near the merchant computing device 140, such as when the user wishes to make a purchase in a store owned by the merchant. In such an arrangement, the information transmitted at 161 may be transmitted using, for example, NFC or Bluetooth. However, in some other arrangements, the mobile device 110 may be remote from the merchant computing device 140, such as when the user wishes to make a purchase via a website operated by the merchant. In such an arrangement, the information transmitted at 161 may be transmitted over the Internet.

At 162, the merchant computing device 140 transmits information to the acquirer processor 145 via the transaction network 120. The information transmitted at 162 can include all of the information transmitted by the mobile device at 161, such as account information, card number information, and authentication information. The information requested at 162 also can include a requested payment amount, as calculated by the merchant computing device 140. The acquirer processor 145 can be owned or operated by a third party who agrees to exchange funds with various other entities, including the financial institution, on behalf of the merchant. Typically, such an agreement involves payment of a fee by the merchant. For example, the fee may be calculated as a percentage of each transaction processed by the acquirer processor 145 on behalf of the merchant 140.

At 163, the acquirer processor 145 transmits information to the payment system 150. The payment system 150 may be owned or operated by another third party, which may be different from the acquirer processor 145. In general, the payment system 150 may be owned by the party who provides the hardware and software used to implement the transaction network 120. In some arrangements, the transaction network 120 comprises multiple card networks, such as Visa®, MasterCard®, American Express®, Discover®, Diners Club®, etc. In such an embodiment, the appropriate card network may be determined based on the first digit of the actual account number (i.e., “4” corresponding to Visa®, “5” corresponding to Mastercard®, “6” corresponding to Discover®, and so on) used for payment. The acquirer processor 145 may therefore route the transaction to the appropriate card network based on the first digit of a card number received it received from the merchant computing device at 162.

At 164, the payment system 150 transmits information to the financial institution computing system 117. The information transmitted at 164 may include any information necessary to complete the transaction, such as account information, card number information, and authentication information originally provided by the mobile device 110 at 161, as well as requested payment amount originally provided by the merchant computing device at 162. The financial institution computing system 117 can determine whether the transaction is approved or denied (e.g., based on the requested payment amount, and an amount of funds available in the account to be used for the transaction). If the transaction is approved, then the financial institution computing system can debit the user's account accordingly and transfer the corresponding funds to an account held by the merchant.

The indication of whether the transaction is approved or denied also can be sent back to the merchant computing device 140 via the transaction network 120. For example, at 165, the financial institution computing system 117 transmits the approval or denial information to the payment system 150; at 166, the payment system 150 transmits the approval or denial to the acquirer processor 145 at 166; and at 167, the acquirer processor 145 transmits the approval or denial to the merchant computing device 140. Finally, the merchant completes the transaction based on the approval or denial. For example, if the merchant computing device 140 receives an indication that the transaction has been approved, then the merchant may remit goods associated with the transaction to the user of the mobile device 161. If the merchant computing device 140 instead receives an indication that the transaction has been denied, then the merchant may request that the user pay using a different form of payment, such as cash or a different financial account.

Thus, using the system of FIG. 1 to conduct a transaction between the user and merchant requires that information be transmitted via the acquirer processor 145 and the payment system 150, both of which may be owned and operated by third parties. Those third parties may each charge a processing fee in order to complete the transaction. As a result, the cost of conducting the transaction may be fairly high and may be particularly burdensome for merchants who process hundreds, thousands, or millions of such transactions per day. Bypassing the proprietary transaction network 120 could help to reduce the cost of each transaction. However, the mobile device 110, the merchant computing device 140, and the financial institution computing system 117 are not typically configured to allow for such transactions to be conducted without the proprietary transaction network 120.

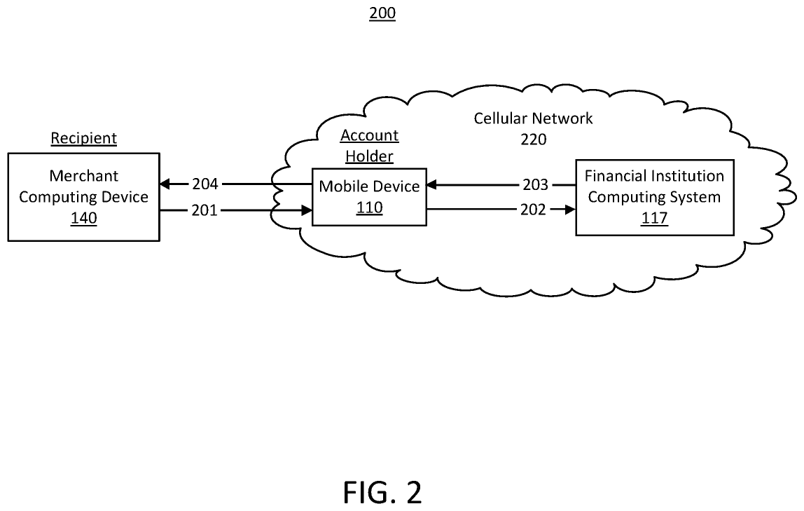

FIG. 2 is a block diagram illustrating data flow in an alternative payment processing system 200 that does not rely on a proprietary transaction network, according to an example embodiment. Using the system 200 can therefore lead to lower transaction costs for merchants and customers. Like the system 100 shown in FIG. 1, the system 200 includes the mobile computing device 110, the financial institution computing system 117, and the merchant computing device 140. However, the system 200 does not include the proprietary transaction network 120, the acquirer processor 145, or the payment system 150. The numbered arrows shown in FIG. 2 illustrate the flow of data between the various computing devices in the system 200.

At 201, the merchant computing device 140 transmits a payment request to the mobile device 110. The payment request includes an indication of the value of the payment requested. In some arrangements, the value can be determined when the merchant computing device scans one or more bar codes associated with goods that the user of the mobile device 110 would like to purchase. It should be understood that, in some implementations, the mobile device 110 may be located near the merchant computing device 140, in which case the information transmitted at 201 may be transmitted using, for example, NFC or Bluetooth. However, in other arrangements, the mobile device 110 may be remote from the merchant computing device 140, and the information transmitted at 161 may be transmitted over the Internet.

The mobile device 110 receives the payment request and, at 202, transmits information to the financial institution computing system 117. The information that the mobile device 110 transmits at 202 can include the payment request, along with any other information necessary to complete the transaction. For example, the information may include account information (such as a number of a bank account held at the financial institution) or authentication information (such as a device token, a username, or a password) that may be used to authenticate the transaction. As shown, the mobile device 110 can transmit this information over a cellular network 220 without any need for a proprietary transaction network. Because most mobile device users pay a flat fee for all of the data they transmit over the cellular network 220 in a given period of time (e.g., one month), the information transmitted at 202 does not incur any additional fee equivalent to the fees described above in connection with use of the proprietary transaction network 120 shown in FIG. 1. It should also be understood that, in some arrangements, any generic computer network may be substituted for the cellular network 220 shown in FIG. 2. For example, in some implementations, the information transmitted at 202 can be transmitted via the Internet.

After receiving the information transmitted at 202, the financial institution computing system 117 can approve or deny the transaction in a manner similar to that described above in connection with FIG. 1. If the transaction is approved, then the financial institution computing system can debit the user's account accordingly and transfer the corresponding funds to an account held by the merchant. The indication of whether the transaction is approved or denied can also be sent back to the merchant computing device 140 without the need for any proprietary transaction network. For example, at 203, the financial institution computing system 117 transmits the approval or denial information to the mobile device 110. The mobile device 110 then transmits the approval or denial to the merchant computing device 140 at 204, and the merchant completes the transaction based on the approval or denial.

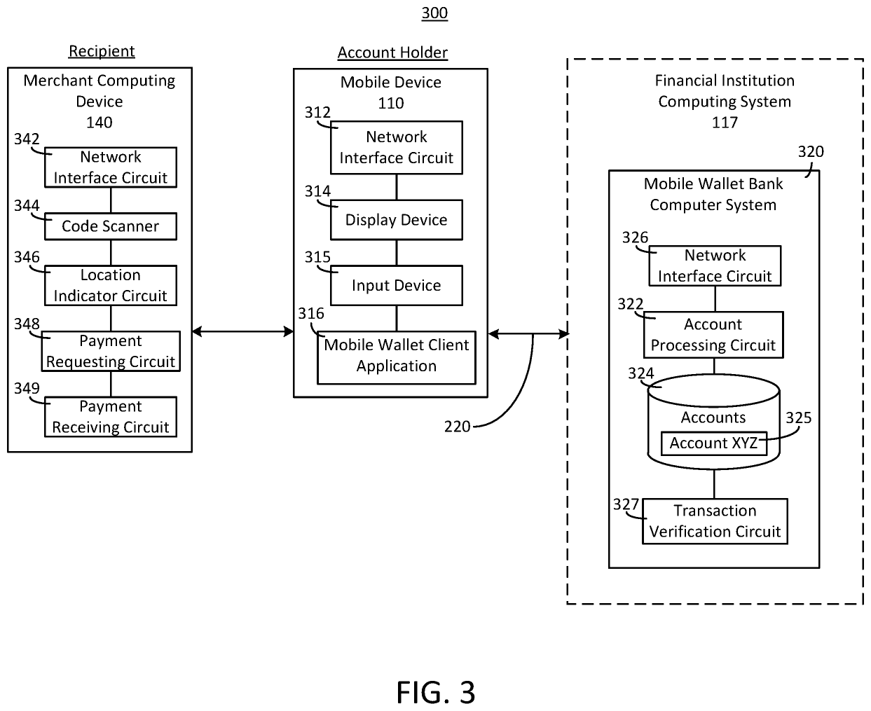

In this example, the transaction is processed without using the transaction network 120, which can reduce the overall cost of the transaction to both the merchant and the user. Thus, the system 200 has the technical benefit of reducing the costs associated with financial transactions. The specific implementations of the mobile device 110, the financial institution computing system 117, and the merchant computing device 140 are described further below in connection with FIG. 3.

FIG. 3 is a block diagram of a computer-implemented payment processing system 300, according to an example embodiment. The payment processing system 300 may include a mobile wallet that facilitates the completion of financial transactions between a user and a merchant (or other recipient) without the use of a proprietary transaction network. As described above, the user may be a business entity and/or an individual consumer that has one or more source accounts with a financial institution. The source accounts may include business or consumer demand deposit, credit card, debit card accounts, lines of credit, and so on. The mobile wallet account may be created for the user to transmit funds from a source account to pay for goods or services to the merchant. Additionally, funds can be transferred from the source account to a different recipient, such as another individual.

The payment processing system 300 includes the mobile device 110, the financial institution computing system 117, and the merchant computing device 140. The financial institution computing system includes a mobile wallet bank computer system 320. The mobile wallet bank computer system 320 can include a computer system (e.g., one or more servers each with one or more processing circuits) having a processor and memory. The processor may be implemented as an ASIC, one or more FPGAs, a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and/or non-transitory computer storage media. The memory may include data base components, object code components, script components, or any other type of information structure for supporting the various activities and information structures described herein. The memory may be communicably connected to the processor and include computer code or instructions for executing one or more processes described herein.

The mobile device 110 may be used by an individual user (e.g., a business owner or employee, a consumer, etc.) to create and interact with a mobile wallet account. The mobile device 110 may, for example, be a cellular phone, a smart phone, a mobile handheld wireless e-mail device, a personal digital assistant, a portable gaming device, or any other suitable device. The mobile device 110 includes a network interface circuit 312, a display device 314, an input device 315, and a mobile wallet client application 316. The network interface circuit 312 may include, for example, program logic that connects the mobile device 110 to the cellular network 220. For example, the mobile device 110 may receive and display interfaces including account information, transaction instructions, and so on. In one embodiment, an interface may be used to request a username and password information from the user and to prompt the user to provide information regarding the amount of a payment and which merchant or individual (e.g., name, address, phone number or e-mail, a selection of a recipient by the user from his/her memory or from the mobile device 110, etc.) is to receive the payment. Such interfaces are presented to the user via the display device 314. The input device 315 may be used to permit the user to initiate account access and to facilitate receiving requested information from the user. The input device 315 may include, for example, a keypad or keyboard, a touchscreen, a microphone, or any other device that allows the user to access the payment processing system 300. As will be appreciated, in addition to or instead of the mobile device 110, users may also be provided with the ability to access the payment processing system 100 using another type of computer (e.g., a desktop or laptop computer executing browser software) to perform the operations described herein as being performed by the mobile device 110.

The mobile wallet client application 316 may include program logic executable by mobile device 110 to implement at least some of the functions described herein. In order to implement the mobile wallet client application 316, the mobile wallet bank computer system 320 may provide a software application and make the software application available to be stored on the mobile device 110. For example, the mobile wallet bank computer system 320 may make the software application available to be downloaded (e.g., via the online banking website of the mobile wallet bank, via an app store, or in another manner). Responsive to a user selection of an appropriate link, the mobile wallet application may be transmitted to the mobile device 110 and may cause itself to be installed on the mobile device 110. Installation of the software application creates the mobile wallet circuit on the mobile device 110. Specifically, after installation, the thus-modified mobile device 110 includes the mobile wallet circuit (embodied as a processor and instructions stored in non-transitory memory that are executed by the processor).

The mobile wallet client application 316 can be used in connection with the merchant computing device 140 located at a brick-and-mortar store location. Additionally, the mobile wallet application 316 may be used in connection with online merchant transactions. In some arrangements, the merchant may be provided with the ability to have a mobile storefront and profile within the mobile wallet client application 316. For example, the merchant may be provided with the ability to display marketing material, provide information, and promote products or discounts. The merchant may also be provided with the ability to sell items directly through its mobile storefront for the account holder to purchase from within the mobile wallet client application 316.

The mobile wallet client application 316 may prompt a user to choose any one of the user's accounts for transferring funds to the merchant for goods or services. The user may also select a default account that is used to make payments. The user may use account selection logic provided by the mobile wallet client application 316 to select the account the user wants to use to pay the merchant or other recipient.

The mobile wallet bank computer system 320 includes an account processing circuit 322, an accounts database 324, a network interface circuit 326, and a transaction verification circuit 327. In one embodiment, the mobile wallet bank computer system 320 is operated by a financial institution that maintains and handles transaction processing for mobile wallet accounts for a plurality of users. The mobile wallet accounts may be created via interaction of the mobile wallet client application 316 with the mobile wallet bank computer system 320, as described above. Each user may have conventional bank accounts with the financial institution that maintains the mobile wallet bank computer system 320.

The mobile wallet bank computer system 320 is configured to store information regarding the mobile wallet accounts. For example, information for a specific mobile wallet account 325 labeled “Account XYZ” is shown as being stored in the accounts database 324. As will be appreciated, the accounts database 324 may also store information regarding many other mobile wallet accounts (not shown). As will also be appreciated, the extent to which transaction details are tracked and maintained in the account processing circuit 322 and/or stored in a storage database provided by the mobile wallet bank computer system 320 may vary in differing embodiments. The account database 324 may store details regarding various accounts, such as credit card accounts, checking accounts, etc. In particular, the account database 324 may store information regarding each financial transaction that occurred for a particular account. The information for each financial transaction may include the amount of the transaction and the merchant associated with the transaction.

The mobile wallet account 325 holds funds that are transmitted to a merchant computing device 140 upon receiving instructions from the user associated with the account 325 through the mobile device 110. As described below, funds can flow into and out of the mobile wallet account 325 through various existing systems, such as clearXchange (not shown). The mobile wallet bank computer system 320 can be connected to such systems via the network interface circuit 326. The network interface circuit 326 may include, for example, program logic that connects the mobile wallet bank computer system 320 to the network 220 and any other systems or networks necessary to implement the functionality described herein.

The mobile wallet bank computer system 320 further includes a transaction verification circuit 327. The transaction verification circuit 327 may receive a transaction amount from the merchant computing device 140. In some embodiments, the transaction verification circuit 327 may generate a message to send to the mobile device 310 for verifying the transaction amount. Upon receiving the verification message, the account holder via the mobile device 110 may approve or deny the transaction amount for the mobile wallet bank computer system 320.

The merchant computing device 140 may be used at a point of sale location to conduct transactions with the account holder. For example, the merchant computing device 140 may include a POS computer system such as a cash register system connected to a central server system operated by the merchant. As another example, the merchant computing device 140 may include a mobile computing device (e.g., smart phone, tablet PC, etc.) operated by a store clerk as the clerk moves throughout the store. Again, the mobile computing device in such an embodiment may connect to a central server system operated by the merchant.

The merchant computing device 140 includes a network interface circuit 342, a code scanner 344, a location indicator circuit 346, a payment requesting circuit 348, and a payment receiving circuit 349. In one embodiment, the network interface circuit 342 is configured to allow the merchant computer system 340 to communicate with the mobile device 110. The network interface circuit 342 sends and receives data from the mobile device 110 and the mobile wallet bank computer system 320.

The code scanner 344 may be configured to scan codes, such as but not limited to, optically scanned or non-optically scanned codes. In the embodiment of the present disclosure, the code scanner 344 scans one or more types of codes. After receiving the code, the scanner 344 determines the information that was incorporated into the code by the mobile device 110 or the mobile wallet bank computer system 320 that generated the code, as described below.

The location indicator circuit 346 provides an indication of the geographic location of the merchant computing device 140. In one embodiment, the location indicator circuit 346 may be programmed with the known address of the merchant location, such that the location of the merchant can be compared with the location of the mobile device 110 as part of authenticating a transaction.

The payment requesting circuit 348 communicates a payment request via the network interface circuit 342 to the mobile device 110. The payment receiving circuit 349 determines when payment has been received by the merchant computing device 140 and allocates the payment accordingly. The merchant computing device 140 may further connect to or integrate with other hardware. For example, in one embodiment, the merchant computing device 140 may connect to a card reader for reading credit cards, debit cards, stored value cards, and so on. As another example, the merchant computing device 140 may be configured to prompt the user to provide a random security code. The random security code may be generated by the mobile device 110, by a separate security device, or in another manner. The security code may be provided to the merchant computing device 140 directly by the mobile device 110, may be keyed into the merchant computing device 140 (e.g., by a store clerk), or may be received in another manner.

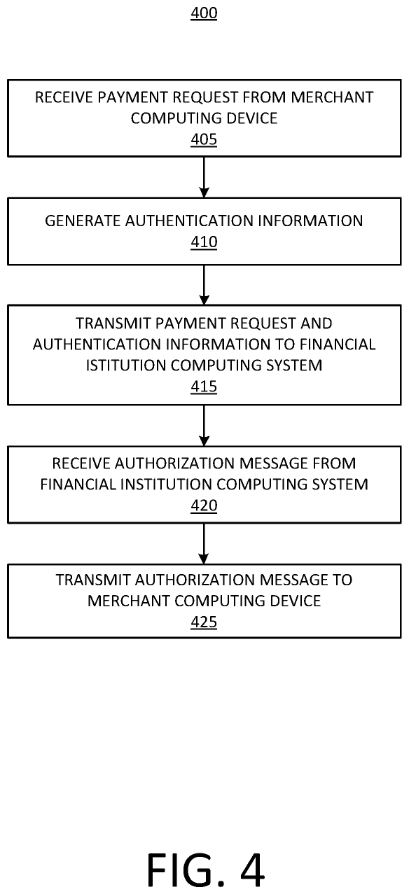

The payment processing system 300 may further include additional bank computer systems that may allow the mobile wallet platform of the present disclosure to be accessed by consumers and merchants that bank at various different banking institutions. The additional bank computer systems may provide the services described herein through multiple banks, allowing for broader adoption of the mobile wallet platform. Additional details regarding the functionality of the various components of the payment processing system 300 are described further below in connection with FIG. 4.

FIG. 4 is a flow chart illustrating a method 400 for facilitating a financial transaction that can be implemented using the payment processing system 300 shown in FIG. 3, according to an example embodiment. Generally, through the method 400, the payment processing system 300 facilitates transactions between a user of a mobile device and a merchant while bypassing traditional proprietary transaction networks. As a result, the method 400 can be used to reduce the cost of processing transactions for both users and merchants. The method 400 is described below with reference to the components of the payment processing system 300 of FIG. 3.

The method 400 begins at 405 when the mobile device 110 receives a payment request from the merchant computing device 140. In some arrangements, the payment request is generated by the payment requesting circuit 348 of the merchant computing device 140. For example, the code scanner 344 can scan one or more products that the user of the mobile device 110 wishes to purchase. The payment requesting circuit 348 can receive the scanned information, and can determine the total price of all scanned products. In some implementations, the payment requesting circuit 348 can also determine the cost of taxes and any other added fees, and can add these costs to the total price. The payment requesting circuit 348 also can determine additional information, such as an identity of the merchant and information identifying the goods or services associated with the transaction. The payment requesting circuit 348 then generates an electronic bill, including all of the payment request information, to be transmitted to the mobile device 110.

In some arrangements, the mobile device 110 can receive the payment request via NFC, Bluetooth, or Wi-Fi. For example, the network interface circuit 342 of the merchant computing device 140 can be configured to transmit the payment request to the mobile device via a predetermined communication protocol, and the network interface circuit 312 of the mobile device 110 can be configured to receive the payment request according to the predetermined communication protocol. In some other arrangements, the mobile device 110 can be configured to receive the payment request in the form of an optically scanned code, such as a QR code. For example, the payment requesting circuit 348 of the merchant computing device 140 can be configured to generate the payment request in the form of an optical code, and the input device 315 of the mobile device 110, which may include optical equipment such as a camera, scans the optical code. In some arrangements, the mobile wallet client application can be configured to extract the payment request information from the scanned optical code.

The mobile device generates authentication information at 410. In some arrangements, the authentication information includes biometric data from the user of the mobile device 110. The biometric data can include information corresponding to the user's voice, the user's fingerprint, the user's iris, or any other type of biometric data. The input device 315 of the mobile device 110 can be configured to allow the user to provide the biometric data. For example, the input device 315 can be a microphone configured to capture audio corresponding to the user's voice. In some other arrangements, the input device 315 can be a camera configured to capture an image corresponding to the user's iris or a fingerprint sensor configured to scan the user's fingerprint. Other forms of authentication information also can be used. For example, the mobile device 110 can store a device token uniquely identifying the mobile device 110 from among other mobile devices. In some implementations, the mobile device 110 can compare its location to a location of the merchant computing device 140 to ensure that the mobile device 110 is physically located near the merchant computing device 140 as an additional form of authentication information.

At 415, the mobile device 110 transmits the payment request and the authentication information to the financial institution computing system 117. The network interface circuit 312 can be configured to facilitate this transmission. In some arrangements, the mobile device 110 transmits the payment request and the authentication information to the financial institution computing system 117 via the cellular network 220. However, it should be understood that any generic, non-proprietary transaction network may be used for this transmission.

At 420, the mobile device 110 receives an authorization message from the financial institution computing system 117. In some arrangements, the transaction verification circuit 327 of the financial institution computing system 117 is configured to determine whether the transaction is approved or denied, and is further configured to include that information in the authorization message. For example, the transaction verification circuit 327 can compare the authentication information received from the mobile device 110 to a set of stored customer information in order to determine whether the payment request should be approved or denied. The stored customer information may include biometric data, a username, a password, a device token for the mobile device 110, or any other information that can be used to authenticate the payment request.

In some other arrangements, the transaction verification circuit 327 is configured to compare the value of the payment request to a balance of the user's account (e.g., the account 325). The transaction verification circuit 327 can then determine that the payment request is approved if the account balance is sufficient to fulfill the payment request, and can determine that the payment request is denied otherwise. If the payment request is approved, the mobile wallet bank computer system 320 can deduct funds equal to the amount of the payment request from the user's account, and can transfer the funds to an account held by the merchant. If the merchant does not maintain an account at the financial institution, then the mobile wallet bank computer system 320 can instead transfer the funds via a different system, such as the clearXchange system.

At 425, the mobile device 110 transmits the authorization message to the merchant computing device 140. In some arrangements, the mobile device 110 can be configured to transmit the authorization using the same communication protocol or optical code that by which the mobile device received the payment request at 405. If the authorization message indicates that the payment request was approved, then the merchant can remit the goods to the user, credit a merchant account associated with the user, or take any other appropriate action. If the authorization message indicates that the payment request was denied, then the merchant can instead seek to obtain payment by a different method. For example, the merchant may ask the user to pay with cash, or with a different financial account.

The method 400 thus allows for the completion of a financial transaction between a user of a mobile device and a merchant without any need for a proprietary transaction network. As described above, this can reduce the total cost of the transaction for both the user and the merchant, relative to the cost of using a proprietary transaction network. Thus, the method 400 represents a substantial technical improvement to the conventional way of processing electronic financial transactions.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method, comprising:
receiving, at a mobile computing device, via user input into a mobile wallet client application executing on the mobile computing device, a selection of an account identifier of a financial account, the selection indicating that the financial account is selected so as to conduct financial transactions without the use of a proprietary transaction network;
receiving, at the mobile computing device, from a merchant computing device via a near-field communication (NFC) signal, an electronic payment request generated by the merchant computing device responsive to the merchant computing device scanning one or more bar codes, the electronic payment request indicating an amount of a financial transaction;
transmitting, by the mobile computing device via a cellular network, to a financial institution computing system corresponding to the financial account, the electronic payment request and authentication information, the authentication information comprising (i) the account identifier selected via the user input to the mobile wallet client application, (ii) a username, and (iii) a password;
receiving, at the mobile computing device via the cellular network, authorization information from the financial institution computing system, the authorization information indicating approval of the electronic payment request by the financial institution computing system; and
transmitting, by the mobile computing device, via a second NFC signal, the authorization information to the merchant computing device, such that the merchant computing device credits a merchant account,
wherein the mobile computing device transmits each of the electronic payment request and the authorization information between the merchant computing device and the financial institution computing system using the cellular network and without use of the proprietary transaction network.

2. The method of claim 1, wherein the electronic payment request includes a payment token issued by the financial institution computing system to the mobile computing device.

3. The method of claim 1, wherein receiving the electronic payment request from the merchant computing device further comprises receiving, at the mobile computing device, the electronic payment request via at least one of Bluetooth, Wi-Fi, or an optically scanned code.

4. The method of claim 1, wherein the electronic payment request further comprises information corresponding to at least one of an identity of a merchant requesting the financial transaction, a value of tax of the financial transaction, and an indication of goods or services of the financial transaction.

5. The method of claim 1, further comprising generating, by the mobile computing device, at least a portion of the authentication information.

6. The method of claim 5, further comprising:
receiving, at the mobile computing device, biometric data from a user of the mobile computing device; and
generating, by the mobile computing device, the authentication information based at least in part on the biometric data received from the user of the mobile computing device.

7. The method of claim 6, wherein the biometric data includes information corresponding to at least one of a voice of the user, a fingerprint of the user, or an iris of the user.

8. The method of claim 1, wherein the financial institution computing system compares the authentication information to stored customer information, and determines that the electronic payment request is approved based on the comparison of the authentication information to the stored customer information.

9. The method of claim 1, wherein the financial institution computing system compares the amount of the financial transaction to a balance of the financial account selected via the user input to the mobile computing device, and determines that the electronic payment request is approved based on the comparison of the amount of the financial transaction to the balance of the financial account held by a user of the mobile computing device.

10. The method of claim 9, wherein the financial institution computing system deducts funds from the financial account selected via the user input to the mobile computing device and transfers the funds to an account held by an owner of the merchant computing device, responsive to determining that the financial transaction is approved.

11. The method of claim 1, wherein:
the electronic payment request does not include the account identifier; and
the financial institution computing system determines an account from which the financial institution computing system is to deduct funds for the financial transaction based on the authentication information.

12. A system comprising a mobile computing device, the mobile computing device configured to:
receive, via user input into a mobile wallet client application executing on the mobile computing device, a selection of an account identifier of a financial account, the selection indicating that the financial account is selected so as to conduct financial transactions without the use of a proprietary transaction network;
receive, from a merchant computing device via a near field communication (NFC) signal, an electronic payment request generated by the merchant computing device responsive to the merchant computing device scanning one or more bar codes, the electronic payment request indicating an amount of a financial transaction;
transmit, via a cellular network, to a financial institution computing system, the electronic payment request and authentication information, the authentication information comprising (i) the account identifier selected via the user input to the mobile wallet client application, (ii) a username, and (iii) a password;
receive, via the cellular network, authorization information from to the financial institution computing system, the authorization information indicating approval of the electronic payment request by the financial institution computing system; and
transmit, via a second NFC signal, the authorization information to the merchant computing device, such that the merchant computing device credits a merchant account,
wherein the mobile computing device is further configured to transmit each of the electronic payment request and the authorization information between the merchant computing device and the financial institution computing system using the cellular network and without use of the proprietary transaction network.

13. The system of claim 12, wherein the electronic payment request includes a payment token issued by the financial institution computing system to the mobile computing device.

14. The system of claim 12, wherein the mobile computing device is further configured to receive the electronic payment request via at least one of Bluetooth, Wi-Fi, or an optically scanned code.

15. The system of claim 12, wherein the electronic payment request further comprises information corresponding to at least one of an identity of a merchant requesting the financial transaction, a value of tax of the financial transaction, and an indication of goods or services of the financial transaction.

16. The system of claim 12, wherein the mobile computing device is further configured to generate at least a portion of the authentication information.

17. The system of claim 16, wherein the mobile computing device is further configured to:
receive biometric data from a user of the mobile computing device; and
generate the authentication information based at least in part on the biometric data received from the user of the mobile computing device.

18. The system of claim 17, wherein the biometric data includes information corresponding to at least one of a voice of the user, a fingerprint of the user, or an iris of the user.

19. The system of claim 12, wherein the financial institution computing system compares the authentication information to stored customer information, and determines that the electronic payment request is approved based on the comparison of the authentication information to the stored customer information.

20. The system of claim 12, wherein the financial institution computing system compares the amount of the financial transaction to a balance of the financial account selected via the user input to the mobile computing device, and determines that the electronic payment request is approved based on the comparison of the amount of the financial transaction to the balance of the financial account.

21. The system of claim 20, wherein the financial institution computing system deducts funds from the financial account selected via the user input to the mobile computing device and transfers the funds to an account held by an owner of the merchant computing device, responsive to determining that the financial transaction is approved.

22. The system of claim 12, wherein:
the electronic payment request does not include the account identifier; and
the financial institution computing system determines the financial account from which to deduct funds for the financial transaction based on the authentication information.
